(19) United States
(12) Patent Application Publication
(10) Pub. No.: US 2012/0104661 A1
(43) Pub. Date: May 3, 2012

(54) SEAMLESS INTERMEDIATE TRANSFER PROCESS

(75) Inventor: Jin Wu, Pittsford, NY (US)

(73) Assignee: XEROX CORPORATION, Norwalk, CT (US)

(21) Appl. No.: 12/917,730

(22) Filed: Nov. 2, 2010

(51) Int. Cl. B29C 35/08

(52) U.S. Cl. 264/496

(57) ABSTRACT

Described herein is a method of forming a seamless transfer member suitable for use with an image forming system. The method includes flow coating a mixture of an ultraviolet (UV) curable mixture comprising a chlorinated polyester resin, a reactive diluent, conductive species and a photoinitiator onto a rotating substrate. The UV curable polymer is cured with ultraviolet energy. The cured UV polymer is removed from the rotating substrate.

### CROSS REFERENCE TO RELATED APPLICATIONS

This application relates to commonly assigned copending application Ser. No. ______ (Docket 20100887-US-NP, XRX-0030), INTERMEDIATE TRANSFER MEMBER AND METHOD OF MANUFACTURE, filed simultaneously herewith and incorporated by reference herein.

### BACKGROUND

1. Field of Use

This disclosure is directed to an intermediate transfer member and a method of manufacture.

2. background

Flow coating a liquid or dispersion on the outside of a rigid cylinder followed by thermal curing has been used to fabricate thermally cured seamless intermediate transfer members. However, such a process requires thermal curing and therefore raises manufacturing costs and results in unwanted organic emissions.

A method of manufacture of seamless intermediate transfer members that reduces emissions and lowers costs would be desirable.

### SUMMARY

Described herein is a method of forming a seamless transfer member suitable for use with an image forming system. The method includes flow coating a mixture of an ultraviolet (UV) curable mixture comprising a chlorinated polyester resin, a reactive diluent, conductive species and a photoinitiator onto a rotating substrate. The UV curable polymer is cured with ultraviolet energy. The cured UV polymer is removed from the rotating substrate.

Described herein is a method of forming a seamless transfer member suitable for use with an image forming system. The method includes flow coating a composition comprising a chlorinated polyester resin, a reactive diluent, conductive species and a photoinitiator onto an inner surface of a rotating cylindrical mandrel wherein the inner surface of the mandrel has a surface roughness Rₐ of from about 0.01 microns to about 1.0 microns. The composition is cured with ultraviolet energy. The cured composition is removed from the cylindrical rotatable mold.

Described herein is a method of forming a seamless transfer member suitable for use with an image forming system. The method includes flow coating a composition comprising a chlorinated polyester resin, a reactive diluent, conductive species and a photoinitiator onto an outer surface of a rotating sheet. The UV polymer is cured with ultraviolet energy. The UV cured polymer is removed from the rotating substrate.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic illustration of an image apparatus.

FIG. 2 is a schematic representation of an apparatus suitable for manufacturing a seamless intermediate transfer member.

FIG. 3 is a schematic representation of an apparatus suitable for manufacturing a seamless intermediate transfer member.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

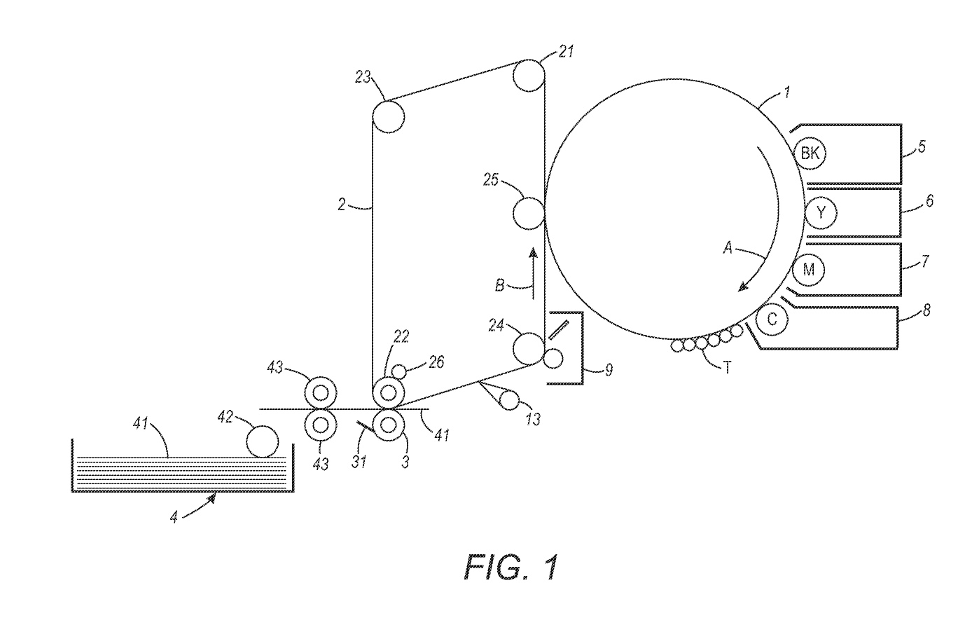

Referring to FIG. 1, an image forming apparatus includes an intermediate transfer member as described in more detail below. The image forming apparatus is an intermediate transfer system comprising a first transfer unit for transferring the toner image formed on the image carrier onto the intermediate transfer member by primary transfer, and a second transfer unit for transferring the toner image transferred on the intermediate transfer member onto the transfer material by secondary transfer. Also, in the image forming apparatus, the intermediate transfer member may be provided as a transfer-conveying member in the transfer region for transferring the toner image onto the transfer material. Having an intermediate transfer belt that transfers images of high quality and remains stable for a long period is required.

The image forming apparatus described herein is not particularly limited as far as it is an image forming apparatus of intermediate transfer type. Examples include an ordinary monochromatic image forming apparatus accommodating only a monochromatic color in the developing device, a color image forming apparatus for repeating primary transfer of the toner image carried on the image carrier sequentially on the intermediate transfer member, and a tandem color image forming apparatus having plural image carriers with developing units of each color disposed in series on the intermediate transfer member. More specifically, the image forming apparatus may arbitrarily comprise an image carrier, a charging unit for uniformly charging the surface of the image carrier, an exposure unit for exposing the surface of the intermediate transfer belt and forming an electrostatic latent image, a developing unit for developing the latent image formed on the surface of the image carrier by using a developing solution and forming a toner image, a fixing unit for fixing the toner unit on the transfer material, a cleaning unit for removing toner and foreign matter sticking to the image carrier, a destaticizing unit for removing the electrostatic latent image left over on the surface of the image carrier, and other known methods as required.

As the image carrier, a known one may be used. As the image carrier's photosensitive layer, an organic system, amorphous silicon, or other known material may be used. In the case of an image carrier of cylindrical type, the image carrier is obtained by a known method of molding aluminum or aluminum alloy by extrusion and processing the surface. A belt form image carrier may also be used.

The charging unit is not particularly limited and known chargers may be used, such as a contact type charger using conductive or semiconductive roller, brush, film and rubber blade, scorotron charger or corotron charge making use of corona discharge, and others. Above all, the contact type charging unit is preferred from the viewpoint of excellent charge compensation capability. The charging unit usually applies DC current to the electrophotographic photosensitive material, but AC current may be further superimposed.

The exposure unit is not particularly limited for example, an optical system device, which exposes a desired image on the surface of the electrophotographic photosensitive material by using a light source such as semiconductor laser beam, LED beam, liquid crystal shutter beam or the like, or through a polygonal mirror from such light source, may be used.

The developing unit may be properly selected depending on the purpose, and, for example, a known developing unit for developing by using one-pack type developing solution or two-pack type developing solution, with or without contact, using brush and roller may be used.

The first transfer unit includes known transfer chargers such as a contact type transfer charger using member, roller, film and rubber blade, and scorotron transfer charger or corotron transfer charger making use of corona discharge. Above all, the contact type transfer charger provides excellent transfer charge compensation capability. Aside from the transfer charger, a peeling type charger may be also used.

The second transfer unit may be the same as the first transfer unit, such as a contact type transfer charger using transfer roller and others, scorotron transfer charger, and corotron transfer charger. By pressing firmly using the transfer roller of the contact type transfer charger, the image transfer stage can be maintained. Further, by pressing the transfer roller or the contact type transfer charger at the position of the roller for guiding the intermediate transfer belt, the action of moving the toner image from the intermediate transfer belt to the transfer material may be performed.

As the photo destaticizing unit, for example, a tungsten lamp or LED may be used, and the light quality used in the photo destaticizing process may include white light of tungsten lamp and red light of LED. As the irradiation light intensity in the photo destaticizing process, usually the output is set to be about several times to 30 times of the quantity of light showing the half exposure sensitivity of the electrophotographic photosensitive material.

The fixing unit is not particularly limited, and any known fixing unit may be used, such as heat roller fixing unit and oven fixing unit.

The cleaning unit is not particularly limited, and any known cleaning device may be used.

A color image forming apparatus for repeating primary transfer is shown schematically in FIG. 1. The image forming apparatus shown in FIG. 1 includes a photosensitive drum 1 as image carrier, an intermediate transfer member 2, shown as an intermediate transfer belt, a bias roller 3 as transfer electrode, a tray 4 for feeding paper as transfer material, a developing device 5 by BK (black) toner, a developing device 6 by Y (yellow) toner, a developing device 7 by M (magenta) toner, a developing device 8 by C (cyan) toner, a member cleaner 9, a peeling pawl 13, rollers 21, 23 and 24, a backup roller 22, a conductive roller 25, an electrode roller 26, a cleaning blade 31, a block of paper 41, a pickup roller 42, and feed rollers 43.

In the image forming apparatus shown in FIG. 1, the photosensitive drum 1 rotates in the direction of arrow A, and the surface of the charging device (not shown) is uniformly charged. On the charged photosensitive drum 1, an electrostatic latent image of a first color (for example, BK) is formed by an image writing device such as a laser writing device. This electrostatic latent image is developed by toner by the developing device 5, and a visible toner image T is formed. The toner image T is brought to the primary transfer unit comprising the conductive roller 25 by rotation of the photosensitive drum 1, and an electric field of reverse polarity is applied to the toner image T from the conductive roller 25. The toner image T is electrostatically adsorbed on the intermediate transfer member 2, and the primary transfer is executed by rotation of the intermediate transfer member 2 in the direction of arrow B.

Similarly, a toner image of a second color, a toner image of a third color, and a toner image of a fourth color are sequentially formed and overlaid on the transfer member 2, and a multi-layer toner image is formed.

The multi-layer toner image transferred on the transfer member 2 is brought to the secondary transfer unit comprising the bias roller 3 by rotation of the transfer member 2. The secondary transfer unit comprises the bias roller 3 disposed at the surface side carrying the toner image of the transfer member 2, backup roller 22 disposed to face the bias roller 3 from the back side of the transfer member 2, and electrode roller 26 rotating in tight contact with the backup roller 22.

The paper 41 is taken out one by one from the paper block accommodated in the paper tray 4 by means of the pickup roller 42, and is fed into the space between the transfer belt 2 and bias roller 3 of the secondary transfer unit by means of the feed roller 43 at a specified timing. The fed paper 41 is conveyed under pressure between the bias roller 3 and backup roller 22, and the toner image carried on the transfer belt 2 is transferred thereon by rotation of the transfer member 2.

The paper 41 on which the toner image is transferred is peeled off from the transfer member 2 by operating the peeling pawl 13 at the retreat position until the end of primary transfer of the final toner image, and conveyed to the fixing device (not shown). The toner image is fixed by pressing and heating, and a permanent image is formed. After transfer of the multi-layer toner image onto the paper 41, the transfer member 2 is cleaned by the cleaner 9 disposed at the downstream side of the secondary transfer unit to remove the residual toner, and is ready for next transfer. The bias roller 3 is provided so that the cleaning blade 31, made of polyurethane or the like, may be always in contact, and toner particles, paper dust, and other foreign matter sticking by transfer are removed.

In the case of transfer of a monochromatic image, the toner image T after primary transfer is immediately sent to the secondary transfer process, and is conveyed to the fixing device. But in the case of transfer of a multi-color image by combination of plural colors, the rotation of the intermediate transfer member 2 and photosensitive drum 1 is synchronized so that the toner images of plural colors may coincide exactly in the primary transfer unit, and deviation of toner images of colors is prevented. In the secondary transfer unit, by applying a voltage of the same polarity (transfer voltage) as the polarity of the toner to the electrode roller 26 tightly contacting with the backup roller 22 disposed oppositely through the bias roller 3 and intermediate transfer member 2, the toner image is transferred onto the paper 41 by electrostatic repulsion. Thus, the image is formed.

The intermediate transfer member 2 described herein is a seamless belt.

The process for the manufacture of polymeric seamless intermediate transfer belt (ITB) for xerographic applications is described herein. The ITB is obtained by flow coating a composition comprising a chlorinated polyester, a UV-curable diluent, a conductive species and a photoinitiator onto a inner surface of a rotating mandrel or an outer surface of a rotating metal substrate. The composition is cured through UV radiation to produce a seamless intermediate transfer member. After coating the composition and UV curing, a UV-cured intermediate transfer belt (ITB) is obtained with functional resistivity, modulus and print quality.

Flow coating requires the coating to be applied to a rotating substrate and applying the coating from an applicator to the substrate in a controlled amount so that substantially all the coating that exits the applicator adheres to the substrate. Specifically, only materials that can be completely dissolved in a solvent can be flow coated. Further, it is desirable that the material have the ability to stay dissolved during the entire flow coating process. Good results are not obtained with materials which tend to coagulate or crystallize within the time period required for flow coating.

This flow coating process of preparing UV cured seamless ITB can be accomplished by flow coated the coating liquid on the outside of a flexible metal belt, or the inside of a hollow rigid cylinder. The coating on either the outside or inside of a substrate is subsequently UV cured in seconds instead of the required lengthy thermal curing. In embodiments, the mixture comprises a viscosity of from about 300 centipoises to about 5000 centipoises, or from about 500 centipoises to about 4000 centipoises or from about 1000 centipoises to about 3000 centipoises

The method described herein provides advantages in manufacturing. A thin stainless sheet can be welded, ground smooth and polished into any circumference belt for a fraction of the cost of a large rigid mandrel. This procedure lowers tooling costs and provides for quicker cycle times to produce an ITB of desired length and width. Belt size can match machine architecture rather than being constrained to existing tooling Finally storage of belt forms, while not in use, take up much less space than the large rigid cylinders.

An advantage of coating on the inside of a hollow rigid cylinder over the outside of a rigid cylinder is that the ITB surface morphology can be readily changed according to the inside finish of the hollow rigid cylinder. For example, the inside finish can be highly polished, honed, dimpled, grooved or otherwise patterned. The surface morphology of the ITB is believed to play a role in performance such as the toner transfer and cleaning efficiency. Thus, a process of fabricating a UV cured seamless ITB with specific surface patterning is further disclosed.

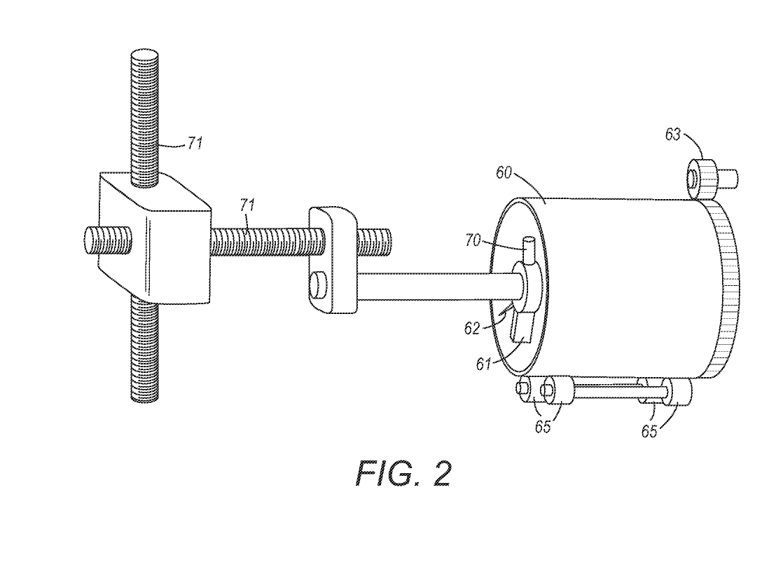

In an embodiment, the process includes flow coating a substantially uniform fluid coating of the composition described above on the interior of a cylindrical mandrel 60 as shown in FIG. 2. The coating is treated with UV radiation which solidifies the coating to form a uniform solid film. The seamless belt has a smooth outer surface whose finish is determined by the finish on the inner surface of the hollow mandrel which is highly polished. The belt can be of any desired length, constrained only by the diameter of the mandrel. The axial dimension of the cylindrical mandrel 60 dictates the width of the fabricated belt. That axial dimension can be configured to be multiple belt widths in size such that the fabricated belt may be sliced into multiple belts after fabrication. Uniform coating is obtained by rotating the mandrel 60 about its axis, through a drive wheel 63, while a flow coating dispensing needle 62 dispenses the liquid coating on the interior of the mandrel 60 in an axial direction. A doctor blade 61 smoothes the coating. The cylindrical mandrel 60 can be supported by rolling members 65. The dispensing needle 62 and doctor blade 61 are positioned in relation to mandrel 60 through an X-Y slide 71. After the coating is applied it is rapidly cured through UV radiation. The UV radiation mechanism can be through an UV lamp 70 attached to the X-Y slide 71. By this process, it is possible to fabricate a belt with varying composition and electrical properties by depositing successive layers of different materials with each traverse of the dispensing needle.

Separation of the belt after coating and drying can be achieved by first depositing a release agent inside the mandrel or by incorporating a release agent in the coating composition itself. Another way of achieving the same goal is to coat a permanent solid layer such as Teflon inside the mandrel surface. Another means to facilitate removal of the dried film from the inside of the mandrel is to take advantage of the differential thermal expansion of the mandrel and the dried film. The belt is solidified through UV curing.

The finish of the outside of the belt fabricated as described above is determined by the inside finish of the mandrel. With diamond lathing and polishing, a very smooth surface of the mandrel can be obtained. The roughness of the inside finish of the mandrel (Rₐ) is from about 0.01 microns to about 1 micron, or from about 0.03 microns to about 0.7 microns, or from about 0.05 microns to about 0.5 microns.

A UV curing lamp 70 can be mounted behind the dispensing needle 62 and doctor blade 61. The UV curing process is very fast and the coated layer is cured quickly. Although any circumferential flow of the wet layer is minimized by the centrifugal forces of the rotating mandrel, quick curing prevents any residual sagging in the wet layer. Thus a belt could is formed in just one single pass. The rotating speed is not critical, but can be selected from a broad range, such as from about 10 rpm to about 500 rpm, or from about 20 rpm to about 200, or from about 30 rpm to about 80 rpm.

The cylindrical mandrel can be made of metals such as stainless steel, nickel, copper, aluminum, and their alloys, or polymers such as polyimide, polyester, or polytetrafluoroethylene. The circumference of the mandrel is, for example, from about 250 millimeters to about 2,500 millimeters, from about 1,500 millimeters to about 2,500 millimeters, or from about 2,000 millimeters to about 2,200 millimeters with a corresponding width of, for example, from about 100 millimeters to about 1,000 millimeters, from about 200 millimeters to about 500 millimeters, or from about 300 millimeters to about 400 millimeters.

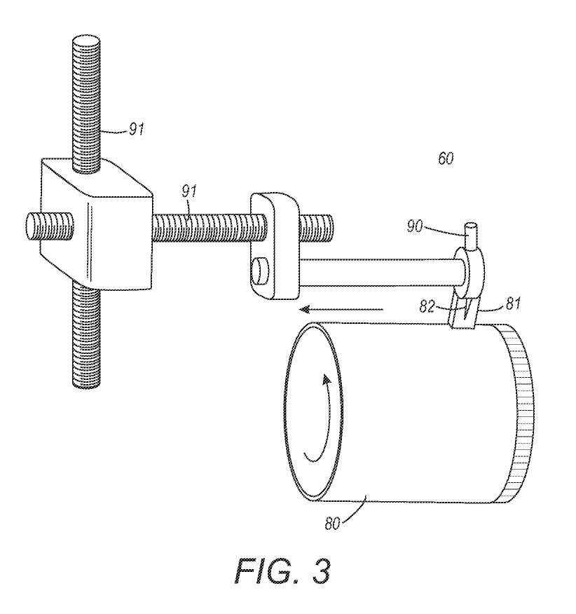

In an embodiment shown in FIG. 3, a flexible metal belt 80 can be a welded stainless steel belt or a seamless nickel belt at the desired product circumference. The belt 80 is rotated while a flow coating dispensing needle 82 dispenses the liquid coating on the exterior surface of the metal belt 80 in an axial direction. A doctor blade 81 smoothes the coating. The dispensing needle 82 and doctor blade 81 are positioned in relation to the metal belt 80 through an X-Y slide mechanism 91. After the coating is applied it is rapidly cured through UV radiation ranging from about 10 seconds to about 240 seconds, or from about 40 seconds to about 200 seconds, or from about 60 seconds to about 120 seconds. The dispensing needle 82 and doctor blade 81 are positioned in relation to metal belt 80 through an X-Y slide 91. The UV radiation mechanism can be a UV lamp 90 attached to the X-Y slide 91. By this process, it is possible to fabricate a belt with varying composition and electrical properties by depositing successive layers of different materials with each traverse of the dispensing needle. The rotating speed is not critical, but can be selected from a broad range, such as from about 10 rpm to about 500 rpm, or from about 20 rpm to about 200, or from about 30 rpm to about 80 rpm.

The belt can be made of metals such as stainless steel, nickel, copper, aluminum, and their alloys, or polymers such as polyimide, polyester, or polytetrafluoroethylene. The circumference of the belt is, for example, from about 250 millimeters to about 2,500 millimeters, from about 1,500 millimeters to about 2,500 millimeters, or from about 2,000 millimeters to about 2,200 millimeters with a corresponding width of, for example, from about 100 millimeters to about 1,000 millimeters, from about 200 millimeters to about 500 millimeters, or from about 300 millimeters to about 400 millimeters.

The combination of UV curing with flow coating increases the manufacture rate, thus increasing the productivity immensely.

The coating composition includes a chlorinated polyester resin which is a modified aliphatic unsaturated polyester resin based on maleic anhydride and a glycol. Examples of the chlorinated polyester resin include GENOMER® 6043, 6050, 6052, 6054, all available from RAHN USA Corp., Aurora, Ill. The chlorinated polyester is formed from the reaction of maleic acid at a weight percent of from about 10 to about 50, or from about 20 to about 40, or from about 25 to about 35, adipic acid at a weight percent of from about 5 to about 45, or from about 15 to about 35, or from about 20 to about 30, diethylene glycol at a weight percent of from about 5 to about 45, or from about 15 to about 35, or from about 20 to about 30, and a chlorinated aromatic aliphatic diol at a weight percent of from about 5 to about 40, or from about 10 to about 30, or from about 15 to about 25. The chlorinated polyester comprises a number average molecular weight (Mn) of from about 500 to about 5,000, or from about 700 to about 3,000, or from about 900 to about 1,500. The chlorinated polyester comprises weight average molecular weight (Mw) of from about 1,000 to about 20,000, or from about 3,000 to about 10,000, or from about 5,000 to about 8,000.

The UV curable diluents include trimethylolpropane triacrylate, hexandiol diacrylate, tripropyleneglycol diacrylate, dipropyleneglycol diacrylate, proxylated neopentylglycol diacrylate, hexamethylene diacrylate, and the like and mixtures thereof.

The conductive species are selected from a group including esters of phosphoric acid such as STEPFAC® 8180, 8181, 8182 (phosphate esters of alkyl polyethoxyethanol), 8170, 8171, 8172, 8173, 8175 (phosphate esters of alkylphenoxy polyethoxyethanol), POLYSTEP® P-11, P-12, P-13 (phosphate esters of tridecyl alcohol ethoxylates), P-31, P-32, P-33, P-34, P-35 (phosphate esters of alkyl phenol ethoxylates), all available from Stepan Corporation; salts of organic sulfonic acid such as sodium sec-alkane sulfonate (ARMOSTAT® 3002 from AKZO Nobel) and sodium C10-C18-alkane sulfonate (HOSTASTAT® HS1FF from Clariant); esters of fatty acids such as HOSTASTAT® FE20liq from Clariant (Glycerol fatty acid ester); ammonium or phosphonium salts such as benzalkonium chloride, N-benzyl-2-(2,6-dimethylphenylamino)-N,N-diethyl-2-oxoethanaminium benzoate, cocamidopropyl betaine, hexadecyltrimethylammonium bromide, methyltrioctylammonium chloride, and tricaprylylmethylammonium chloride, behentrimonium chloride (docosyltrimethylammonium chloride), tetradecyl(trihexyl)phosphonium chloride, tetradecyl(trihexyl)phosphonium decanoate, trihexyl(tetradecyl)phosphonium bis 2,4,4-trimethylpentylphosphinate, tetradecyl(trihexyl)phosphonium dicyanamide, triisobutyl(methyl)phosphonium tosylate, tetradecyl(trihexyl)phosphonium bistriflamide, tetradecyl(trihexyl)phosphonium hexafluorophosphate, tetradecyl(trihexyl)phosphonium tetrafluoroborate, Ethyl tri(butyl)phosphonium diethylphosphate, etc. The weight ratio of the conductive species ranges from about 5 to about 30, or from about 10 to about 25, or from about 15 to about 20 weight percent of the total ITB. The surface resistivity range of from about 10⁸ ohms/square to about 10¹³ ohms/square, or from about 10¹⁰ ohms/square to about 10¹² ohms/square. The volume resistivity is from about 10⁸ ohm-cm to about 10¹² ohm-cm, or from about 10⁹ ohm-cm to about 10¹¹ ohm-cm.

Any suitable photoinitiators can be used, including, but not limited to, acyl phosphines, α-hydroxyketones, benzyl ketals, α-aminoketones, and mixtures thereof, which photoinitiators are selected in various suitable amounts, such as illustrated herein, and, for example, from about 0.1 to about 20 weight percent, or from about 1 to about 10 weight percent, or from about 3 to about 7 weight percent, or from 1 to about 5 weight percent of the UV cured layer components.

The volume (or bulk) resistivity and the surface resistivity of the final ITB coating layer can be uniform with minimal variation. For example, a maximum value of volume resistivity can be within the range of 1 to 10 times the minimum value, and a maximum value of surface resistivity can be within the range of 1 to 100 times the minimum value.

The formed ITB can have a surface resistivity ranging from about 10⁸ ohms/sq to about 10¹³ ohms/sq, or ranging from about 10⁹ ohms/sq to about 10¹² ohms/sq, or ranging from about 10¹⁰ ohms/sq to about 10¹¹ ohms/sq. In embodiments, the formed ITB coating can have a mechanical Young's modulus ranging from about 500 MPa to about 10,000 MPa, or ranging from about 1,000 MPa to about 5,000 MPa, or ranging from about 1,500 MPa to about 3,000 MPa. In embodiments, the ITB is seamless and the ITB has a belt width ranging from about 8 inches to about 40 inches and a circumference ranging from about 8 inches to about 60 inches although any width and length is possible depending on the mandrel. In embodiments, the ITB has a total thickness of from about 30 microns to about 500 microns.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

Experimentally, about 10 grams of STEPFAC® 8180, a phosphate ester of alkyl polyethoxyethanol (Stepan Corporation, Northfield, Ill.) was mixed with about 85 grams of GENOMER® 6054, a chlorinated polyester resin in proxylated neopentylglycol diacrylate (Mₙ=1,000 and M_{w}=7,300, RAHN USA Corp., Aurora, Ill.). About 5 grams of IRGACURE® 500 (Ciba Specialty Chemicals, Tarrytown, N.Y.) was added to the above mixture to form a homogeneous coating solution, where IRGACURE® 500 is a 1/1 mixture of 1-hydroxy-cyclohexyl-phenyl-ketone and benzophenone.

The coating solution was coated on a glass plate using a draw bar coating method, and subsequently cured using a Hanovia UV instrument (Fort Washington, Pa.) for about 40 seconds at a wavelength of about 325 nm (about 250 watts). The UV cured composite film (GENOMER® 6054/STEPFAC® 8180/IRGACURE® 500=85/10/5) was then released from the glass plate and had a thickness of about 100 μm.

The intermediate transfer member was measured for surface resistivity (averaging four to six measurements at varying spots, 72° F./65% room humidity) using a High Resistivity Meter (Hiresta-Up MCP-HT450 available from Mitsubishi Chemical Corp.). The surface resistivity was about 4.7×10¹⁰ ohm/square, within the functional range of an ITB of from about 10⁸ to about 10¹³ ohm/square.

The intermediate transfer member was measured for Young's modulus following the ASTM D882-97 process. A sample of the disclosed intermediate transfer member was placed in the measurement apparatus, an Instron Tensile Tester, and then elongated at a constant pull rate until breaking During this time, the instrument recorded the resulting load versus sample elongation. The modulus was calculated by taking any point tangential to the initial linear portion of this curve and dividing the tensile stress by the corresponding strain. The tensile stress was given by load divided by the average cross sectional area of the test specimen. The results are shown in Table 1 along with resistivity and hardness.

TABLE 1

| | Modulus | Surface resistivity |
|---|---|---|
| | (MPa) | (ohm/sq) |
| The disclosed UV cured ITB | 1,500 | 4.7 × 10¹⁰ |
| (polyester ITB), thermally cured | 1,200 | 7.9 × 10¹¹ |
| (polyamide ITB), thermally cured | 1,100 | 1.0 × 10¹³ |
| (PVDF ITB), thermally cured | 1,000 | 6.3 × 10⁹ |
| (polyimide ITB), thermally cured | 3,500 | 5.1 × 10¹¹ |

The disclosed UV cured ITB exhibited a higher modulus than most commercially available thermoplastic ITBs including those made of polyester, polyamide and PVDF. When compared with the polyimide ITB, the disclosed UV cured ITB exhibited lower modulus.

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled in the art which are also encompassed by the following claims.

What is claimed is:

1. A method of forming a seamless transfer member suitable for use with an image forming system, comprising:
flow coating a mixture comprising an ultraviolet (UV) curable mixture comprising a chlorinated polyester resin, a reactive diluent, conductive species and a photoinitiator onto an rotating substrate;
curing the mixture with ultraviolet energy; and
removing the cured UV polymer from the rotating substrate.

2. The method of claim 1 further wherein the mixture comprises a viscosity of from about 300 centipoises to about 5000 centipoises.

3. The method of claim 1 wherein the conductive species are selected from the group consisting of esters of phosphoric acid, salts of organic sulfonic acid, esters of fatty acids, ammonium salts, phosphonium salts and mixtures thereof.

4. The method of claim 1 wherein the conductive species comprises from about 5 to about 30 weight percent of the UV curable mixture.

5. The method of claim 1, wherein the reactive diluent is selected from the group consisting of trimethylolpropane triacrylate, hexandiol diacrylate, tripropyleneglycol diacrylate, dipropyleneglycol diacrylate, proxylated neopentylglycol diacrylate, hexamethylene diacrylate and mixtures thereof.

6. The method of claim 1, wherein the photoinitiator is selected from the group consisting of acyl phosphines, α-hydroxyketones, benzyl ketals, α-aminoketones, and mixtures thereof.

7. The method of claim 1, wherein the rotating substrate comprises a flexible metal belt or polymeric belt.

8. The method of claim 7, wherein the mixture is flow coated on an outer surface of the flexible metal belt or polymeric belt.

9. The method of claim 7 wherein the flexible metal belt is rotated at a speed of from about 100 rpm to about 1500 rpm.

10. The method of claim 1, wherein the rotating substrate comprises a rigid metal cylinder or polymeric cylinder.

11. The method of claim 10, wherein the mixture is flow coated on an inner surface of the rigid cylinder wherein the inner surface comprises a surface roughness Rₐ of from about 0.01 micron to about 1.0 micron.

12. The method of claim 10 wherein the rigid cylinder is rotated at a speed of from about 100 rpm to about 1500 rpm.

13. A method of forming a seamless transfer member suitable for use with an image forming system, comprising:
flow coating a composition having a viscosity of from about 300 centipoises to about 5000 centipoises wherein the composition comprises an ultraviolet (UV) curable mixture comprising a chlorinated polyester resin, a reactive diluent, conductive species and a photoinitiator onto an inner surface of a rotating cylindrical mandrel wherein the inner surface of the mandrel has a surface roughness of Rₐ of from about 0.01 microns to about 1.0 microns;
curing the composition with ultraviolet energy; and
removing the cured composition from the cylindrical rotatable mold.

14. The method of claim 13 wherein the conductive species are selected from the group consisting of esters of phosphoric acid, salts of organic sulfonic acid, esters of fatty acids, ammonium salts, phosphonium salts and mixtures thereof.

15. The method of claim 13 wherein the conductive species comprises from about 5 to about 30 weight percent of the UV curable mixture.

16. The method of claim 13, wherein the reactive diluent is selected from the group consisting of trimethylolpropane triacrylate, hexandiol diacrylate, tripropyleneglycol diacrylate, dipropyleneglycol diacrylate, proxylated neopentylglycol diacrylate, hexamethylene diacrylate and mixtures thereof.

17. A method of forming a seamless transfer member suitable for use with an image forming system, comprising:
flow coating a composition having a viscosity of from about 300 centipoises to about 5000 centipoises wherein the composition comprises an ultraviolet (UV) curable mixture comprising a chlorinated polyester resin, a reactive diluent, conductive species and a photoinitiator on an outer surface of a rotating sheet;
curing the UV polymer with ultraviolet energy; and
removing the cured UV polymer from the rotating substrate.

18. The method of claim 17 wherein the conductive species are selected from the group consisting of esters of phosphoric acid, salts of organic sulfonic acid, esters of fatty acids, ammonium salts, phosphonium salts and mixtures thereof.

19. The method of claim 17, wherein the reactive diluent is selected from the group consisting of trimethylolpropane triacrylate, hexandiol diacrylate, tripropyleneglycol diacrylate, dipropyleneglycol diacrylate, proxylated neopentylglycol diacrylate, hexamethylene diacrylate and mixtures thereof.

20. The method of claim 17, wherein rotating sheet comprises a material selected from the group consisting of stainless steel, nickel, polyester and polytetrafluoroethylene.
